(19) United States
(12) Patent Application Publication
(10) Pub. No.: US 2025/0372702 A1
(43) Pub. Date: Dec. 4, 2025

(54) WIDE-TEMPERATURE-RANGE SOLID-STATE ELECTROLYTE, PREPARATION METHOD THEREFOR AND USE THEREOF IN SOLID-STATE LITHIUM METAL BATTERIES

(71) Applicant: SHANDONG UNIVERSITY, Jinan (CN)

(72) Inventors: Longwei YIN, Jinan (CN); Jiafeng LI, Jinan (CN)

(73) Assignee: SHANDONG UNIVERSITY, Jinan (CN)

(21) Appl. No.: 19/218,722

(22) Filed: May 27, 2025

(30) Foreign Application Priority Data
May 28, 2024 (CN) 202410670859.7

(51) Int. Cl. H01M 10/0562

(52) U.S. Cl. CPC H01M 10/0562; H01M 2300/0068; H01M 2300/0085

(57) ABSTRACT

Provided are a wide-temperature-range solid-state electrolyte, a preparation method thereof and use thereof in solid-state lithium metal batteries. The preparation method includes: dissolving a lithium salt and a magnesium salt in a solvent to obtain a mixed salt solution; and mixing the mixed salt solution with an ammonia fluoride solution, subjecting a resulting mixture to reaction, and subjecting a resulting reaction product to centrifugation, washing, and drying in sequence to obtain magnesium-doped lithium fluoride nanoparticles; and mixing the magnesium-doped lithium fluoride nanoparticles, a liquid plasticizer, a polymer monomer and a thermal initiator to obtain a liquid precursor, and subjecting the liquid precursor to curing to obtain the wide-temperature-range solid-state electrolyte, where the polymer monomer is a mixture of ethoxylated trimethylolpropane triacrylate and hexafluorobutyl methacrylate.

### CROSS REFERENCE TO RELATED APPLICATION

This patent application claims the benefit and priority of Chinese Patent Application No. 202410670859.7 filed with the China National Intellectual Property Administration on May 28, 2024, the disclosure of which is incorporated by reference herein in its entirety as part of the present application.

### TECHNICAL FIELD

The present disclosure relates to the technical field of solid-state batteries, and specifically relates to a wide-temperature-range solid-state electrolyte, a preparation method thereof and use thereof in solid-state lithium metal batteries.

### BACKGROUND

With the rapid development of electric vehicles and portable electronic devices, higher requirements are made on the energy density, safety and cycle life of energy storage devices. Moreover, in order to promote the efficient storage and utilization of clean energy such as wind power and hydropower, it is urgent to develop a new energy storage device with an ultra-high energy density. Due to the ultra-high theoretical specific capacity (3860 mAh g⁻¹) and the low standard potential (−3.04 V vs standard hydrogen electrode) of lithium metal anode, lithium metal batteries exhibit a significantly higher energy density than traditional secondary lithium-ion batteries, positioning the lithium metal batteries as a leading candidate for next-generation lithium batteries. However, lithium metal batteries face severe lithium dendrite growth during charge/discharge process, which could easily cause short circuit inside the battery by penetrating a separator. Further, the employment of flammable and volatile organic electrolytes is prone to safety accidents such as combustion and explosion when the battery is short-circuited. Replacing organic electrolytes with intrinsically safe solid-state electrolytes is one of the effective strategies to solve the above safety problems.

The solid-state electrolyte is disposed between a cathode and an anode in the battery. On the one hand, the solid-state electrolyte functions to separate the cathode and the anode of the battery to prevent the battery from short circuiting. One the other hand, the solid-state electrolyte also serves as an ionic conductor to facilitate the ion transport between the cathode and the anode. Therefore, the ionic conductivity is one of the main indicators for evaluating the performance of solid-state electrolytes. Solid-state electrolytes are primarily categorized into solid-state inorganic electrolytes and solid-state polymer electrolytes. Solid-state inorganic electrolytes have a high room-temperature ionic conductivity, but the complex preparation processes and serious interfacial contact problems between the solid-state inorganic electrolytes and electrodes significantly limit their practical applications. Solid-state polymer electrolytes featuring excellent mechanical flexibility could effectively reduce the electrode-electrolyte interface resistance. However, the intrinsic ionic conductivity of polymer electrolytes is low, which cannot meet practical requirements.

Gel polymer electrolytes are composed of polymer backbones, lithium salts and liquid plasticizers. Organic electrolytes are the most common liquid plasticizers. Therefore, gel electrolytes have both the safety properties of polymer electrolytes and the excellent ionic conductivity of organic electrolytes, enabling them to be desirable electrolyte materials for lithium metal batteries. However, the liquid plasticizers could lead to severe interfacial side reactions, forming a loose and porous anode solid electrolyte interphase (SEI) layer, which is difficult to suppress lithium dendrites. Especially under low-temperature, not only the ionic conductivity of the solid-state electrolyte drops sharply, but also the formation of SEI layer on the surface of the anode becomes slower, severely limiting the practical application of lithium metal power batteries in cold conditions.

Therefore, it is imperative to develop a gel electrolyte with a high ionic conductivity, a desirable SEI layer, effective suppression of lithium dendrite and excellent low temperature properties.

### SUMMARY

In view of the defects present in the prior art, the present disclosure provides a wide-temperature-range solid-state electrolyte, a preparation method thereof and use thereof in solid-state lithium metal batteries. The present disclosure overcomes the problems of low ionic conductivity of gel electrolytes and structural destabilization of SEI layers in the prior art, enabling effective suppression of lithium dendrite, and resulting in excellent low temperature properties, and a solid-state electrolyte membrane provided by the present disclosure exhibits excellent electrochemical properties in a wide temperature range of −20° C. to 80° C., and is of great innovation and application value.

The technical solutions of the present disclosure are as follows:

A method for preparing a wide-temperature-range solid-state electrolyte, including the steps of:
(1) dissolving a lithium salt and a magnesium salt in a solvent to obtain a mixed salt solution; and uniformly mixing the mixed salt solution with an ammonia fluoride solution, subjecting a resulting mixture to reaction, and then subjecting a resulting reaction product to centrifugation, washing, and drying in sequence to obtain magnesium-doped lithium fluoride nanoparticles; and
(2) thoroughly and uniformly mixing the magnesium-doped lithium fluoride nanoparticles, a liquid plasticizer, a polymer monomer and a thermal initiator to obtain a liquid precursor of a gel electrolyte; and subjecting the liquid precursor to curing to obtain the wide-temperature-range solid-state electrolyte, where the polymer monomer is a mixture of ethoxylated trimethylolpropane triacrylate (ETPTA) and hexafluorobutyl methacrylate (HFBMA).

According to some embodiments of the present disclosure, in step (1), the lithium salt is lithium nitrate and the magnesium salt is magnesium nitrate; and a molar ratio of the lithium salt to the magnesium salt is in a range of 2:1 to 19:1. In some embodiments, the molar ratio of the lithium salt to the magnesium salt is in a range of 9:1 to 19:1. In some embodiments, the molar ratio of the lithium salt to the magnesium salt is in a range of 19:1.

According to some embodiments of the present disclosure, in step (1), the solvent is diethylene glycol; and the lithium salt in the mixed salt solution has a molar concentration of 1 mol/L to 10 mol/L.

According to some embodiments of the present disclosure, in step (1), the preparation of the mixed salt solution is carried out under the protection of nitrogen or argon.

According to some embodiments of the present disclosure, in step (1), the ammonia fluoride solution is a solution of ammonium fluoride in diethylene glycol; the ammonia fluoride solution has a concentration of 0.5 mol/L tol mol/L; and the ammonia fluoride solution is prepared under the protection of nitrogen or argon.

According to some embodiments of the present disclosure, in step (1), the mixed salt solution is added dropwise to the ammonia fluoride solution.

According to some embodiments of the present disclosure, in step (1), after mixing the mixed salt solution with the ammonia fluoride solution, the resulting mixture is stirred at room temperature for 3 minutes to 7 minutes to mix to be uniform.

According to some embodiments of the present disclosure, in step (1), a ratio of a total molar amount of the lithium salt and the magnesium salt in the mixed salt solution to a molar amount of ammonia fluoride is in a range of 1:1 to 1:1.3.

According to some embodiments of the present disclosure, in step (1), the reaction is carried out at a temperature of 70° C. to 100° C. for 1 minute to 5 minutes.

According to some embodiments of the present disclosure, in step (2), the liquid plasticizer is 0.5 mol/L to 1.5 mol/L of a solution of lithium bistrifluoromethanesulfonimide (LiTFSI) in a mixed solvent of 1,3 dioxolane (DOL) and ethylene glycol dimethyl ether (DME); and in the mixed solvent, a volume ratio of the DOL to the DME is 1:1.

According to some embodiments of the present disclosure, in step (2), in the polymer monomer, a volume ratio of the ETPTA to the HFBMA is in a range of 1:1 to 2:1.

According to some embodiments of the present disclosure, in step (2), the thermal initiator is azobisisobutyronitrile (AIBN).

According to some embodiments of the present disclosure, in step (2), a ratio of a mass of the magnesium-doped lithium fluoride nanoparticles and a volume of the liquid plasticizer and a volume of the polymer monomer and a mass of the thermal initiator is in a range of 50-150 mg: 0.5-3 mL: 0.2-0.6 mL: 6-10 mg; In some embodiments, the ratio of the mass of the magnesium doped lithium fluoride nanoparticles and the volume of the liquid plasticizer and the volume of the polymer monomer, and the mass of the thermal initiator is in a range of 100 mg: 0.5-3 mL: 0.2-0.6 mL: 6-10 mg.

According to some embodiments of the present disclosure, in step (2), the liquid precursor of the gel electrolyte is prepared under the protection of nitrogen or argon.

According to some embodiments of the present disclosure, in step (2), the curing is carried out at a temperature of 50°° C. to 70°° C. under the protection of nitrogen or argon for 1 hour to 6 hours.

The present disclosure further provides a wide-temperature-range solid-state electrolyte prepared by the method described above.

The present disclosure further provides use of the wide-temperature-range solid-state electrolyte prepared by the method described above as an electrolyte for solid-state lithium metal batteries.

According to some embodiments of the present disclosure, the solid-state lithium metal batteries each includes: an anode, a cathode, and a solid-state electrolyte membrane disposed between the cathode and the anode.

In some embodiments, the solid-state electrolyte membrane has a thickness of 40 μm to 50 μm; the solid-state electrolyte membrane is prepared by a process including the steps of: under the protection of argon or nitrogen, immersing a cellulose separator in a liquid precursor of a gel electrolyte, then tanking out to obtain an electrolyte precursor-loaded cellulose separator, and subjecting the electrolyte precursor-loaded cellulose separator to curing in situ at a temperature of 50° C. to 70° C. for 1-6 hours to obtain the solid-state electrolyte membrane.

According to the disclosure, the cathode and anode could be made according to the prior art.

In some embodiments, the cathode is prepared by a process including the steps of: thoroughly grinding and mixing an active substance, a conductive agent, and a binder, and dissolving a resulting mixture in N-methylpyrollidone as a solvent to obtain a slurry; and coating an aluminum foil with the slurry, drying a resulting coated aluminum foil to obtain a positive electrode sheet, where the active substance is selected from the group consisting of iron phosphate and lithium cobaltate, the conductive agent is super P, and the binder is polyvinylidene fluoride (PVDF); a mass ratio of the active substance, the conductive agent and the binder is in a range of 6-10:1:1; and a total loading of the active substance, the conductive agent and the binder on the cathode sheet is 3 mg/cm² to 4 mg/cm².

In some embodiments, the anode is a lithium metal sheet.

According to some embodiments of the present disclosure, each of the solid-state lithium metal batteries is prepared by a process including the steps of: under the protection of argon or nitrogen, immersing the cellulose separator in the liquid precursor of the gel electrolyte, and then taking out to obtain the electrolyte precursor-loaded cellulose separator; and then assembling the anode, the electrolyte precursor-loaded cellulose separator, and the cathode in sequence, and then subjecting a resulting assembled system to curing in situ at a temperature of 50° C. to 70° C. for 1-6 hours to obtain the solid-state lithium metal battery.

Some embodiments of the present disclosure include the following technical features and have the following beneficial effects:

1. The magnesium-doped lithium fluoride nanoparticles (MgₓLi₁₋ₓF) prepared by the method according to the present disclosure are hollow nanoparticles with an average size of 10-20 nm. Large-sized magnesium ions successfully enter the LiF lattice, which exhibits a higher surface reactivity due to its distortion and local rearrangement of electronic structures. The polymer matrix is formed by in-situ polymerization of ETPTA and HFBMA. The ETPTA monomer molecules have a triple unsaturated alkenyl group and have a strong chemical crosslinking ability, which allows the electrolyte have high mechanical properties and film-forming properties. The perfluorinated molecular structure of HFBMA provides the polymer matrix with a strong molecular polarity, enabling strong molecular interactions between them and the surface of MgₓLi₁₋ₓF fillers. Additionally, the rich fluorinated alkyl side chains of HFBMA could regulate and weaken the coordination between lithium-ions and the solvation shells, reducing the energy barrier for lithium-ion transfer. Benefiting from the strong interaction between lattice-activated MgₓLi₁₋ₓF nanofillers and the polar polymer matrix, the thermodynamically unstable Fions on the surface of MgₓLi₁₋ₓF are stripped by the polar side chains of the polymer, forming free ions, and then rapidly forming a LiF-rich SEI layer on the surface of the lithium anode. The SEI yerwith LiF as the main component has the advantages of a fast ion transport, a strong chemical stability, etc. It could effectively regulate the deposition behavior of lithium metal at the anode interface and suppress lithium dendrite growth, and also physically isolate the liquid plasticizer from the lithium anode and suppress the further reductive decomposition of the liquid plasticizer in the gel electrolyte, so as to protect the lithium anode. The liquid plasticizer in the present disclosure is preferably a LiTFSI solution, which is mainly distributed in the interstices of the polymer segments, giving the polymer electrolyte excellent ionic conductivity. Furthermore, due to differences in the chemical valence of magnesium and lithium-ions, the surface of MgₓLi₁₋ₓF nanoparticles exhibits localized cathode electrical characteristics, which can effectively promote the dissociation of lithium salts, releasing more free lithium-ions, and effectively anchor TFSI anions by coulombic forces, which in turn improves the lithium-ion transfer number. In this way, the gel electrolyte of the present disclosure not only has excellent ionic conductivity and lithium dendrite suppression capability at room temperature, but also exhibits an outstanding electrochemical performance even at the low temperature of −20° C. and the high temperature of 80° C., and has an outstanding practical application value.

2. The preparation method according to the present disclosure is simple, has mild conditions and is easily achieved. In addition, raw materials are low in costs, simple and easily available, environment friendly, and suitable for industrial large-scale production. The battery assembly process of the present disclosure is the same as that for the liquid battery. The existing mature liquid lithium battery production line could be used to quickly realize industrial production and large-scale application of solid-state batteries, without further retrofitting and upgrading the production equipment.

3. In the preparation of the magnesium-doped lithium fluoride nanoparticles according to the present disclosure, the choice of a solvent is important; if not suitable, the size and morphology of the magnesium-doped lithium fluoride product will be irregular or the doping of magnesium ions cannot be achieved. The molar ratio of the lithium salt to the magnesium salt needs to be appropriate; if not appropriate, Mg ions will segregate in the form of MgF₂, and cannot be doped into LiF lattice, or is less doped. The amount of magnesium-doped lithium fluoride nanoparticles needs to be appropriate; if not appropriate, the electrochemical performance of the resulting solid-state electrolyte will be reduced. The curing temperature should not be higher than 70° C., otherwise the initiator will decompose thermally, which will affect the thermal curing process of the liquid precursor.

4. The solid-state electrolytes according to the present disclosure exhibit high room-temperature ionic conductivity (1.37 mS cm⁻¹) and low-temperature ionic conductivity (up to 0.44 mS cm⁻¹ at −20° C.). When applied in solid-state lithium metal batteries, the solid-state electrolyte of the present disclosure exhibits excellent room-temperature cycling performance (82% capacity retention after 600 cycles at a high rate of 1C), high-temperature cycling performance (safely running for 200 cycles at 80° C.) and low-temperature cycling performance (running 500 cycles at −20° C., with 100% capacity recovery upon returning to room temperature). It could meet the service requirements of all-weather power batteries and is at the leading level among similar batteries.

### BRIEF DESCRIPTION OF THE DRAWINGS

FIG. 1A shows X-Ray Diffraction (XRD) patterns of lithium fluoride obtained in Examples 1-4 and Comparative Example 3 of the present disclosure; FIG. 1B shows X-ray photoelectron spectroscopy (XPS) spectrums of lithium fluoride obtained in Example 1 and Comparative Example 3 of the present disclosure; FIG. 1C shows a transmission electron microscope (TEM) image of lithium fluoride obtained in Example 1 of the present disclosure; and FIG. 1D shows Zeta potential profiles of lithium fluoride obtained in Example 1 and Comparative Example 3 of the present disclosure;

FIG. 2 shows an XRD pattern of lithium fluoride prepared in Comparative Example 1 and Comparative Example 3 of the present disclosure;

FIG. 3 is a scanning electron microscope (SEM) image of lithium fluoride prepared in Comparative Example 2 of the present disclosure;

FIG. 4A shows Infrared Spectroscopy (IR) spectrums of a polar HFBMA molecule, a HFBMA-LiF mixture, and a HFBMA-MgₓLi₁₋ₓF mixture; FIG. 4B shows Raman spectrums (RS) of an electrolyte, an electrolyte-LiF mixture, an electrolyte-MgₓLi₁₋ₓF mixture; and FIG. 4C shows Nuclear Magnetic Resonance (NMR) spectrums of an electrolyte, and an electrolyte-HFBMA mixture;

FIG. 5 shows Electrochemical Impedance Spectroscopy (EIS) spectrums of solid-state electrolyte assembled stainless steel symmetric cells prepared in Comparative Example 3, Example 1, Example 5, and Example 6 of the present disclosure at room temperature;

FIG. 6A to FIG. 6D show the polarization curves and electrochemical impedance spectrums before and after polarization of solid-state electrolyte membrane assembled lithium metal symmetric batteries in Comparative Example 3, Example 5, Example 1 and Example 6;

FIG. 7 is a graph showing the ionic conductivity and ion transfer number of solid-state electrolytes prepared in Comparative Example 3, Example 1, Example 5, and Example 6 of the present disclosure at room temperature;

FIG. 8 shows cyclic voltage curves of solid-state electrolyte assembled lithium metal symmetric cells prepared in Example 1, Comparative Example 3 and Comparative Example 4 of the present disclosure at a current density of 0.2 mA cm⁻²;

FIG. 9A to FIG. 9C show SEM images of the lithium metal surface of solid-state electrolyte assembled lithium metal symmetric cells prepared in Example 1 of the present disclosure, Comparative Example 3 and Comparative Example 4 of the present disclosure after cycling;

FIG. 10A and FIG. 10B show XPS spectrums of the lithium metal surface of solid-state electrolyte assembled lithium metal symmetric cells prepared in Example 1, Comparative Example 3 and Comparative Example 4 of the present disclosure after cycling;

FIG. 11A and FIG. 11B show cycling performance curves and rate performance curves of a solid-state lithium metal batteries prepared in Example 1, Comparative Example 3, and Comparative Example 4 of the present disclosure at room temperature;

FIG. 12 shows a cycling performance curve of a solid-state lithium metal battery prepared in Example 1 of the present disclosure at a high temperature of 80° C.; and

FIG. 13 shows a cycling performance curve of a solid-state lithium metal battery prepared in Example 1 of the present disclosure at a low temperature of −20° C.

### DETAILED DESCRIPTION OF THE EMBODIMENTS

The following examples are provided for a better understanding of the present disclosure, but are not intended to limited to the preferred embodiments, nor do they limit the content or scope of protection of the disclosure. Any product identical or similar to the present disclosure, derived either from the inspiration from this disclosure or from combining features of this disclosure with other prior arts, shall fall within the scope of the present invention.

Specific experimental steps or conditions that are not specified in examples are conducted according to the conventional experimental steps or conditions in the art. Reagents or instruments used therein on which no manufacturers are specified are all commercially available conventional reagent products.

### Example 1

A method for preparing a wide-temperature-range solid-state electrolyte was conducted by the steps of:
(1) 76 mmol of lithium nitrate and 4 mmol of magnesium nitrate were dissolved in 20 mL of diethylene glycol (GC) under nitrogen, and a resulting mixture was thoroughly stirred until completely dissolved to obtain a mixed salt solution. 84 mmol of ammonia fluoride was dissolved in 100 mL of diethylene glycol under nitrogen, an obtained mixture was thoroughly stirred until completely dissolved to obtain an ammonia fluoride solution. The mixed salt solution was slowly added dropwise to the ammonia fluoride solution in air under stirring, a resulting solution was subjected to stirring at room temperature for 5 minutes to obtain a milky white solution. The milky white solution was subjected to heating to 90° C. under air, holding at the 90° C. for 2 minutes, cooling to room temperature, and then high-speed centrifugation for 3 minutes at 8000 rpm. A supernatant was removed. A residual product was subjected to washing with deionized water three times to obtain a white precipitate. The white precipitate was subjected to freeze-drying to obtain an MgₓLi₁₋ₓF white powder (magnesium doped lithium fluoride nanoparticles) as a gel electrolyte filler of the present disclosure.
(2) 100 mg of the MgₓLi₁₋ₓF powder was added to 1 mL of an organic electrolyte (1 mol/L LiTFSI DOL: DME=1:1 vol %), and a resulting system was subjected to sealing and ultrasonically dispersing for 10 minutes to obtain an MgₓLi₁₋ₓF dispersion. The MgₓLi₁₋ₓF dispersion was transferred into an Ar atmosphere glove box. 200 μL of ETPTA and 200 μL of HFBMA were added dropwise to the MgₓLi₁₋ₓF dispersion, and stirred thoroughly for 10 minutes. Then, 8 mg of an AIBN initiator was added thereto and stirred until thoroughly dispersed to obtain a liquid precursor of the gel electrolyte. The liquid precursor of the gel electrolyte was subjected to curing by heating at 60° C. for 2 hours in the Ar atmosphere glove box to obtain the wide-temperature-range solid-state electrolyte.

This example further provides a solid-state lithium metal battery, which consists of: an anode, a cathode, and a solid-state electrolyte membrane disposed between the cathode and the anode.

The cathode was prepared by the steps of: an active substance of lithium iron phosphate, a conductive agent of super P, and a binder of PVDF were subjected to thoroughly grinding and mixing at a mass ratio of 8:1:1. A resulting mixed power was dissolved in N-methylpyrollidone as a solvent to obtain a slurry. An aluminum foil was coated with the slurry and then dried to obtain a cathode sheet, where a total loading of the active substance, the conductive agent and the binder on the cathode sheet is 3 mg/cm². The anode was a lithium metal sheet.

A method for preparing the solid-state lithium metal battery was conducted by the steps of: under the protection of argon or nitrogen, a cellulose separator (with a thickness of 35 μm) was immersed in the liquid precursor of a gel electrolyte, and taken out to obtain an electrolyte precursor-loaded cellulose separator. The anode, the electrolyte precursor-loaded cellulose separator, and the cathode were assembled in sequence to obtain a battery. After the battery assembly was completed, a resulting system was cured in situ at 60° C. for 2 hours to obtain the solid-state lithium metal battery. The electrolyte precursor-loaded cellulose separator was cured to obtain a solid-state electrolyte membrane with a thickness of 40-45 μm.

### Example 2

A method for preparing a wide-temperature-range solid-state electrolyte was conducted as described in Example 1, except that in step (1), lithium nitrate and magnesium nitrate were used in an amount of 72 mmol and 8 mmol, respectively, the other steps and conditions were the same as those in Example 1.

The structure of the solid-state lithium metal battery and the preparation method thereof were the same as those in Example 1.

### Example 3

A method for preparing a wide-temperature-range solid-state electrolyte was conducted as described in Example 1, except that in step (1), lithium nitrate and magnesium nitrate were used in an amount of 64 mmol and 16 mmol, respectively, the other steps and conditions were the same as those in Example 1.

The structure of the solid-state lithium metal battery and the preparation method thereof were the same as those in Example 1.

### Example 4

A method for preparing a wide-temperature-range solid-state electrolyte was conducted as described in Example 1, except that in step (1), lithium nitrate and magnesium nitrate were used in an amount of 56 mmol and 24 mmol, respectively, the other steps and conditions were the same as those in Example 1.

The structure of the solid-state lithium metal battery and the preparation method thereof were the same as those in Example 1.

### Example 5

A method for preparing a wide-temperature-range solid-state electrolyte was conducted as described in Example 1, except that in step (2), 50 mg of MgₓLi₁₋ₓF was added, the other steps and conditions were the same as those in Example 1.

The structure of the solid-state lithium metal battery and the preparation method thereof were the same as those in Example 1.

### Example 6

A method for preparing a wide-temperature-range solid-state electrolyte was conducted as described in Example 1, except that in step (2), 150 mg of MgₓLi₁₋ₓF was added, the other steps and conditions were the same as those in Example 1.

The structure of the solid-state lithium metal battery and the preparation method thereof were the same as those in Example 1.

### Comparative Example 1

A method for preparing a solid-state electrolyte was conducted as described in Example 1, except that in step (1), the solvent used in the mixed salt solution and the ammonium fluoride solution was methanol; the other steps and conditions were the same as those in Example 1.

The structure of the solid-state lithium metal battery and the preparation method thereof were the same as those in Example 1.

### Comparative Example 2

A method for preparing a solid-state electrolyte was conducted as described in Example 1, except that in step (1), the solvent used in the mixed salt solution and the ammonium fluoride solution was deionized water; the other steps and conditions were the same as those in Example 1.

The structure of the solid-state lithium metal battery and the preparation method therefor were s the ame as those in Example 1.

### Comparative Example 3

A method for preparing a solid-state electrolyte was conducted as described in Example 1, except that in step (1), lithium nitrate and magnesium nitrate were used in an amount of 80 mmol and 0 mmol, respectively, the other steps and conditions were same as those in Example 1, and LiF was obtained; and in step (2), 100 mg MgₓLi₁₋ₓF was changed to 100 mg LiF; the other steps and conditions were the same as those in Example 1.

The structure of the solid-state lithium metal battery and the preparation method thereof were the same as those in Example 1.

### Comparative Example 4

A method for preparing a solid-state electrolyte was conducted by the steps of:
400 μL ETPTA was added into 1 mL of an organic electrolyte (1 mol/L LiTFSI DOL: DME=1:1 vol %) in an Ar atmosphere glove box, and thoroughly stirred for 10 minutes. 8 mg of an AIBN initiator was added thereto, and stirred until the AIBN initiator was dissolved to obtain a liquid precursor of a gel electrolyte. The liquid precursor of the gel electrolyte was subjected to curing by heating at 60° C. for 2 hours in the Ar atmosphere glove box to obtain a solid-state electrolyte.

The structure of the solid-state lithium metal battery and the preparation method thereof were the same as those in Example 1.

### Test Example 1

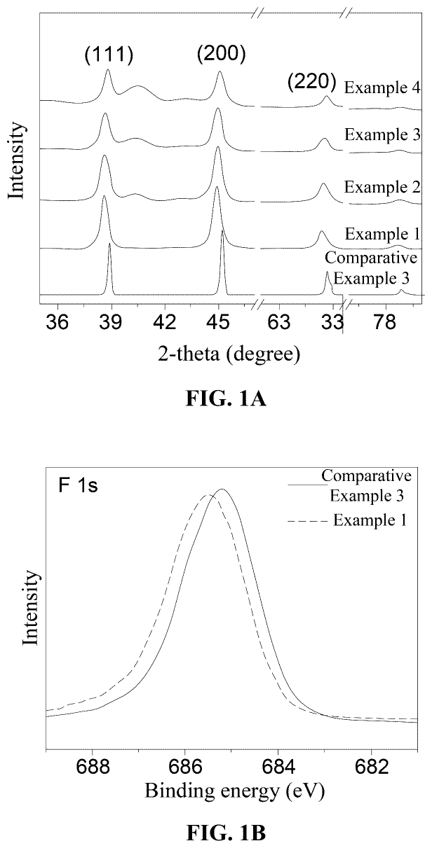

FIG. 1A shows the XRD patterns of lithium fluoride samples prepared by the methods described in Examples 1-4 and Comparative Example 3. The results show that the positions of the corresponding characteristic peaks of (111) (200) and (220) crystal planes in Example 1 are shifted toward a small angle direction compared with the pure phase lithium fluoride obtained in Comparative Example 3, indicating that the corresponding interplanar crystal spacing is increased, which proves that magnesium ions are successfully doped into the lithium fluoride lattice. The XRD characteristic peak shift of the sample obtained in Example 1 is most pronounced, indicating that the actual doping of magnesium ions is greatest. In addition, the XRD results of Examples 2-4 show an impurity peak of magnesium fluoride at 40 degrees. Therefore, the magnesium-doped lithium fluoride nanoparticles obtained in Example 1 are of optimal quality. FIG. 1B shows the XPS spectrums of lithium fluoride obtained in Example 1 and Comparative Example 3. The F1 s orbital binding energy of Example 1 is shifted in the direction of a high binding energy, which is caused by the decrease in electron density outside the F nucleus due to the successful doping of Mg ions. FIG. 1C shows a TEM image of the magnesium-doped lithium fluoride powder obtained in Example 1, with a size of approximately 20 nm. FIG. 1D shows the test results of the Zeta potential of lithium fluoride obtained in Example 1 and Comparative Example 3. The results show that the surface of Example 1 is positively charged and the surface of Comparative Example 3 (pure phase lithium fluoride) is negatively charged, which is due to the formation of local electron-deficient sites after doping with +2 magnesium ions, and the positively charged surfaces can form Coulomb interactions with lithium salt anions, promoting the dissociation of lithium salts, and thus increasing lithium-ion conductivity.

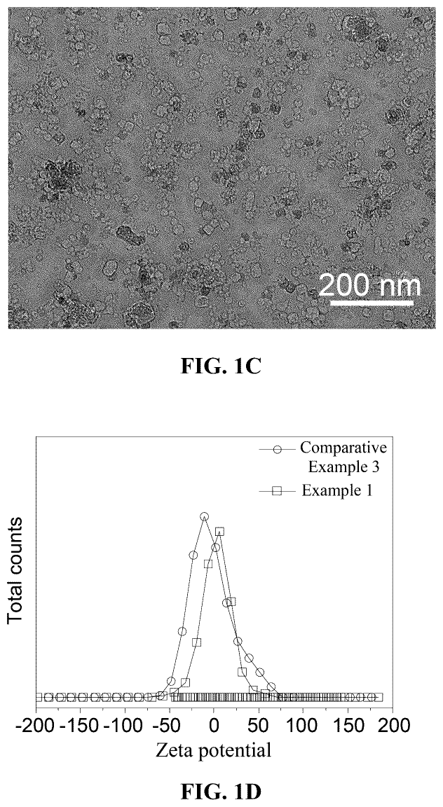

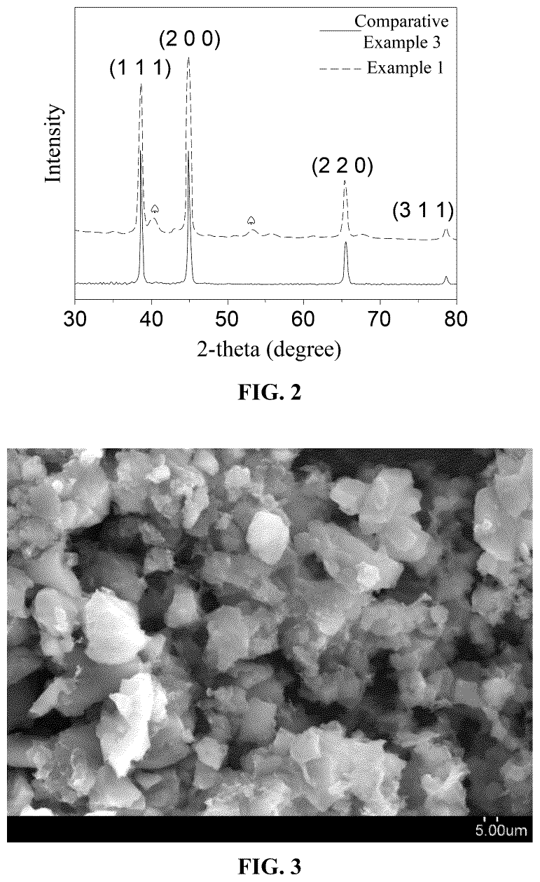

FIG. 2 shows the XRD patterns of magnesium-doped lithium fluoride prepared in Comparative Example 1 and lithium fluoride prepared in Comparative Example 3. The results show that magnesium ions cannot be doped into the crystal lattice of the lithium fluoride in the samples prepared in a methanol solvent. FIG. 3 is an SEM image of the magnesium-doped lithium fluoride prepared in Comparative Example 2, demonstrating that the samples synthesized in water are micron-sized bulks with irregular size and morphology, lacking well-defined nanostructures.

### Test Example 2

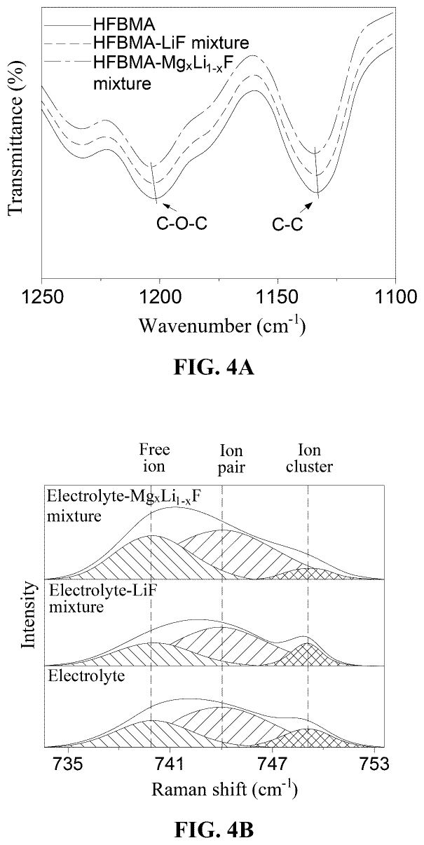

FIG. 4A shows infrared spectrograms of a polar HFBMA molecule, a HFBMA-LiF mixture (a mixture of 200 μL HFBMA and 100 mg of LiF prepared in Comparative Example 3), and a HFBMA-MgₓLi₁₋ₓF mixture (a mixture of 200 μL HFBMA and 100 mg of MgₓLi₁₋ₓF prepared in Example 1). The results demonstrate that the characteristic peak shift of HFBMA is more pronounced when mixing with MgₓLi₁₋ₓF, which shows stronger interface interaction between the MgₓLi₁₋ₓF filler prepared in Example 1 and HFBMA polymer, thus it is easier to release free Fions, which in turn form in situ a LiF-rich SEI layer on the lithium anode surface.

FIG. 4B shows Raman spectrograms of a commercial electrolyte (1 mol/L LiTFSI DOL: DME=1:1 vol %), a commercial electrolyte-LiF mixture (a mixture of 100 mg of LiF prepared in Comparative Example 3 and 1 mL of a commercial electrolyte), and a commercial electrolyte-MgₓLi₁₋ₓF mixture (a mixture of 100 mg MgₓLi₁₋ₓF prepared in Example 1 and 1 mL of a commercial electrolyte). The results show the proportion of free TFSI is increased significantly after mixing the commercial electrolyte and MgₓLi₁₋ₓF, indicating that the MgₓLi₁₋ₓF prepared in Example 1 could effectively promote the dissociation of lithium salts, thus releasing more free lithium-ions and promote lithium-ion transport.

FIG. 4C shows the NMR spectrums of a commercial electrolyte (1 mol/L LiTFSI DOL: DME=1:1 vol %) and a commercial electrolyte-HFBMA mixture (a mixture of 200 μL HFBMA and 1 mL of a commercial electrolyte). The results show that the electron density outside the lithium-ion nucleus decreases and the desolvation energy barrier of lithium-ion transition decreases after the addition of HFBMA molecules to the electrolyte, indicating that HFBMA in the polymer is beneficial to weaken the solvation energy of lithium-ions, promoting lithium-ion transport.

### Test Example 3

A stainless steel symmetric battery was assembled from a stainless steel electrode, a solid-state electrolyte membrane, and a stainless steel electrode in sequence by using a 2025 battery case. The solid-state electrolyte was tested for the electrochemical impedance and the lithium-ionic conductivity was calculated. The stainless steel electrode area was 1.91 cm² and the solid-state electrolyte membrane thickness was 45 μm. The assembly method for the stainless steel symmetric cell was the same as that for the solid-state lithium metal battery of Example 1.

The lithium metal symmetric battery was assembled from a lithium metal, a solid-state electrolyte membrane, and a lithium metal in sequence by using a 2032 battery case. The assembly method for the lithium metal symmetric battery is the same as that for the solid-state lithium metal battery in Example 1. The lithium metal symmetric battery was tested for polarization at a voltage of 10 mV and electrochemical impedance was tested before and after polarization, respectively. The ion transfer number of the solid-state electrolyte membrane was calculated.

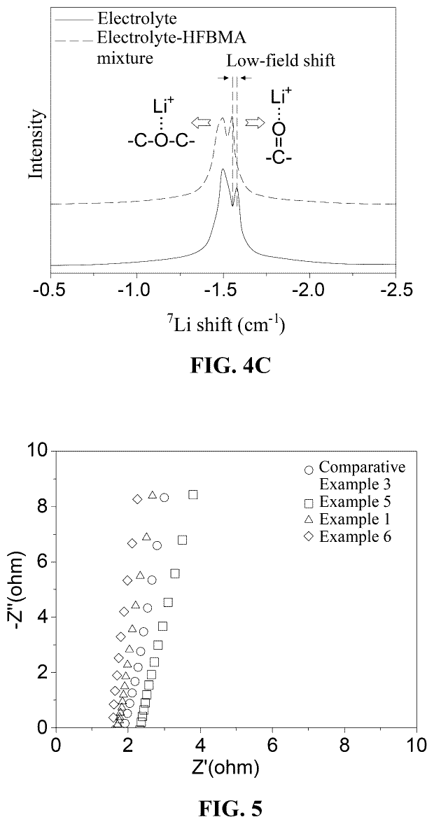

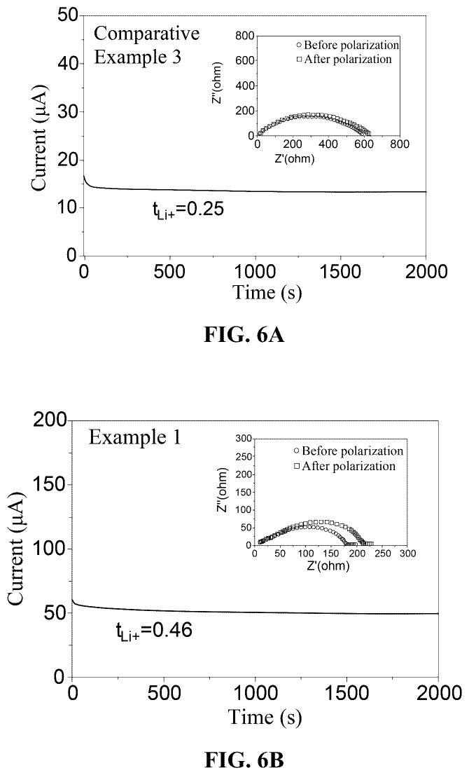

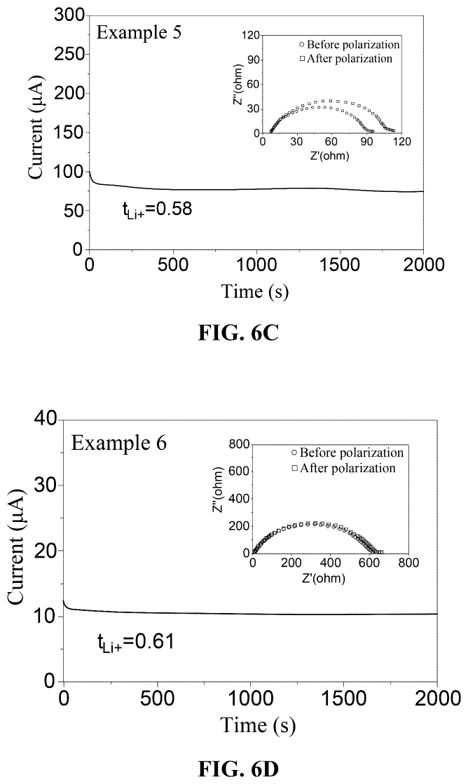

FIG. 5 shows electrochemical impedance spectrums of solid-state electrolyte membrane assembled stainless steel symmetric batteries in Comparative Example 3, Example 5, Example 1, and Example 6; FIG. 6A to FIG. 6D show the polarization curves and electrochemical impedance spectrums before and after polarization of solid-state electrolyte membrane assembled lithium metal symmetric batteries in Comparative Example 3, Example 5, Example 1 and Example 6; FIG. 7 shows the ionic conductivity and ion transfer number of the solid-state electrolyte membranes in Comparative Example 3, Example 5, and Examples 1 and 6.

The results show that the ionic conductivity and ion transfer number of the solid-state electrolyte membrane increases were both significantly improved with the increase of the addition amount of MgₓLi₁₋ₓF in the solid-state electrolyte membrane, and the ionic conductivity and ion transfer number of the solid-state electrolyte membranes in Example 1 and Example 6 were higher than those in Comparative Example 3. The room-temperature ionic conductivity of Example 1 reaches 1.37 mS cm⁻¹ and the ion transfer number reaches 0.58; the ionic conductivity at −20° C. reaches 0.44 mS cm⁻¹. Thus, the ion transport capacity of the solid-state electrolyte is significantly enhanced under a combined action of MgₓLi₁₋ₓF nanofillers and polar polymers.

However, the high level of MgₓLi₁₋ₓF filler could lead to increased viscosity of the electrolyte precursor, which in turn leads to increased impedance between the electrode and the electrolyte. It can be seen form FIG. 6A to FIG. 6D that the interface impedance of the lithium metal symmetric cell of Example 6 is significantly greater compared to those in Comparative Example 3, Example 5 and Example 1. Therefore, the solid-state electrolyte membrane prepared in Example 1 has the best overall performance.

### Test Example 4

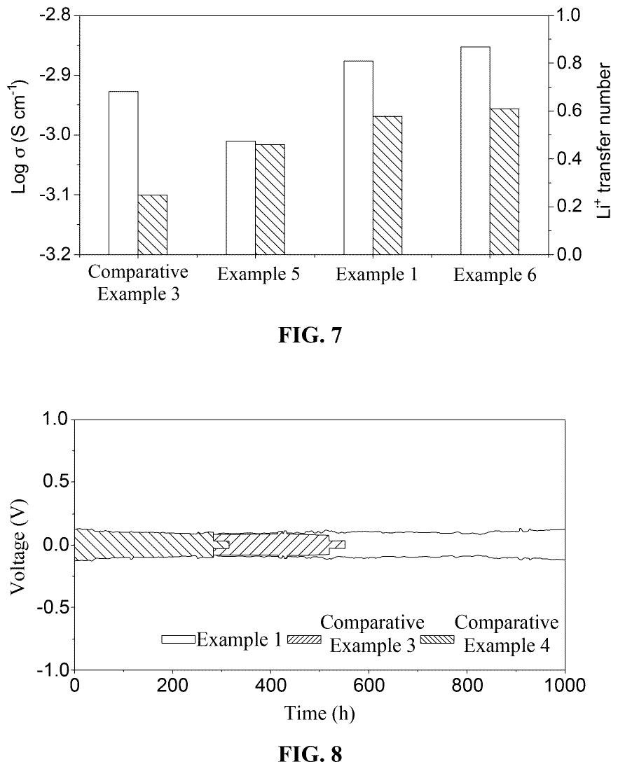

A lithium metal symmetric battery was assembled from a lithium metal, a solid-state electrolyte membrane, and a lithium metal in sequence by using a 2032 battery case. The dendrite suppression capability of solid-state electrolytes was tested. The assembly method for the lithium metal symmetric cell was the same as that for the solid-state lithium metal battery of Example 1. FIG. 8 shows the cycling voltage curves of the solid-state electrolyte-assembled lithium metal symmetric cells obtained in Example 1, Comparative Example 3 and Comparative Example 4, with a cycling current density of 0.2 mA cm⁻². The results show that the short circuit of the batteries in Comparative Example 3 and Comparative Example 4 after 510 hours and 280 hours of cycling, respectively, and the solid-state electrolyte obtained in Example 1 remained stable after 1000 hours of cycling.

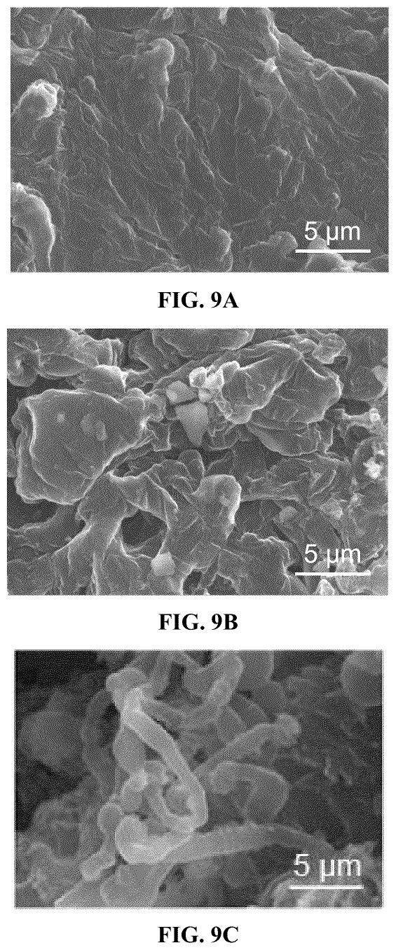

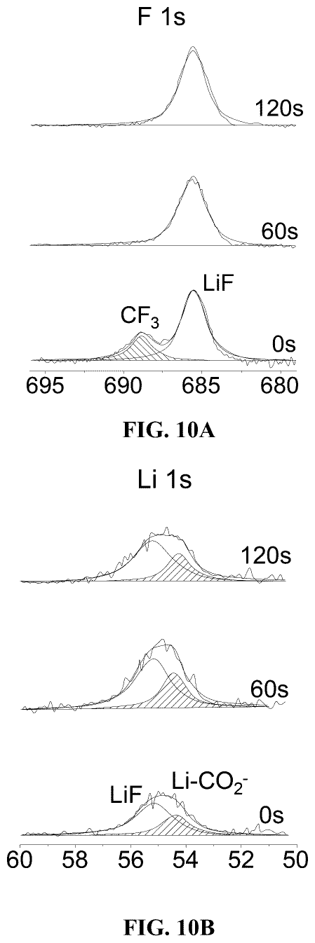

FIG. 9A to FIG. 9C show SEM images of lithium anode corresponding to lithium metal symmetric batteries of Example 1, Comparative Example 3 and Comparative Example 4, after cycling at a current density of 0.2 mA cm⁻² for 100 hours, respectively. The results show that the lithium metal anode in Example 1 has the flattest surface after cycling, with a significant metal dendrite being not observed, indicating that the polar polymer and magnesium doped lithium fluoride can effectively suppress lithium dendrite growth. FIG. 10A and FIG. 10B show the XPS spectrum of the surface of lithium anode in Example 1 after cycling. The XPS data were collected after Ar etching for 0 s, 60 s and 120 s, respectively, to reflect the component information of the SEI layer at different depths. The XPS F spectrum results show that the F element exists only in the form of LiF inside the SEI layer, while the Li spectrum results show that the main components in the SEI layer are lithium fluoride and lithium carbonate. Lithium fluoride is significantly higher than lithium carbonate. Therefore, the interaction between the polar polymer and the magnesium-doped lithium fluoride could promote the formation of an SEI layer rich in lithium fluoride inorganic phase, thus achieving uniform deposition of lithium metal.

### Test Example 5

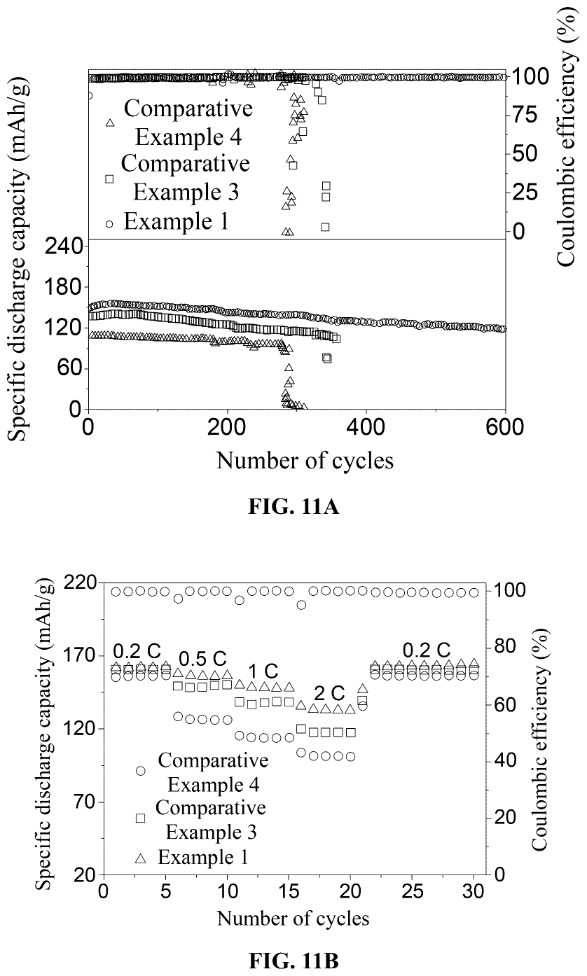

FIG. 11A and FIG. 11B are test results of long-term cycling performance and rate performance of the solid-state lithium metal batteries prepared in Example 1, Comparative Example 3 and Comparative Example 4, respectively. The long-term cycling test was carried out at room temperature (25° C.) at a rate of 1C; and the rate performance was carried out at room temperature, at 0.2-2 C. The results in FIG. 11A show that Example 1 has the highest long-term cycling stability, with a capacity retention of 82% after 600 cycles, and Comparative Example 3and Comparative Example 4 show short circuit after 280 cycles and 360 cycles, respectively. FIG. 11B demonstrates the discharge specific capacities of Example 1 are is 157.5, 152.3, 144.9, and 130.9 mAh g⁻¹ at 0.2 C, 0.5 C, 1 C, and 2 C, respectively.

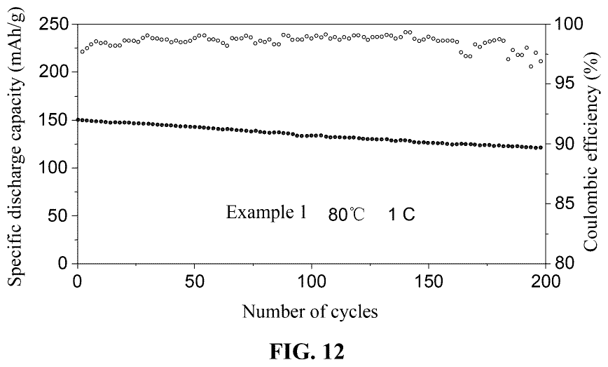

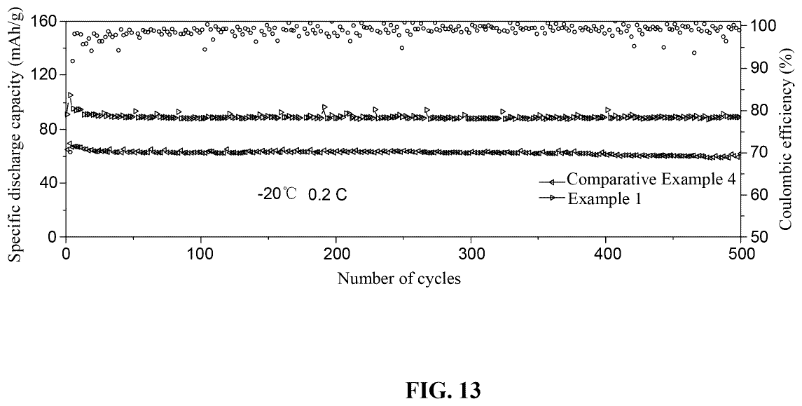

FIG. 12 shows the cycling performance curve of the solid-state lithium metal battery prepared in Example 1 at an elevated temperature of 80° C., with an initial specific discharge capacity of 149.8 mAh g⁻¹ at a rate of 1 C and 80.1% capacity retention after safely running 200 cycles. FIG. 13 illustrates the cycling performance curves of the solid-state lithium metal batteries prepared in Example 1 and Comparative Example 4 at −20° C. Example 1 shows an initial specific discharge capacity of 95 mAh g⁻¹ at −20° C. and a rate of 0.2 C, with a capacity retention of 95% after 500 cycles, and the capacity recovered 100% when it returned to room temperature. The initial discharge specific capacity of Comparative Example 4 is only 67 mAh⁻¹ under the same conditions. Therefore, the solid-state lithium metal battery prepared in Example 1 exhibits an excellent long-term cycling stability over a wide-temperature range.

What is claimed is:

1. A method for preparing a wide-temperature-range solid-state electrolyte, comprising steps of:
(1) dissolving a lithium salt and a magnesium salt in a solvent to obtain a mixed salt solution; and mixing the mixed salt solution with an ammonia fluoride solution, subjecting a resulting mixture to a reaction, and subjecting a resulting reaction product to centrifugation, washing, and drying in sequence to obtain magnesium-doped lithium fluoride nanoparticles; and
(2) mixing the magnesium-doped lithium fluoride nanoparticles, a liquid plasticizer, a polymer monomer, and a thermal initiator to obtain a liquid precursor of a gel electrolyte, and subjecting the liquid precursor to curing to obtain the wide-temperature-range solid-state electrolyte, wherein the polymer monomer is a mixture of ethoxylated trimethylolpropane triacrylate (ETPTA) and hexafluorobutyl methacrylate (HFBMA).

2. The method for preparing the wide-temperature-range solid-state electrolyte of claim 1, wherein in step (1), the lithium salt is lithium nitrate and the magnesium salt is magnesium nitrate; and a molar ratio of the lithium salt to the magnesium salt is in a range of 2:1 to 19:1.

3. The method for preparing the wide-temperature-range solid-state electrolyte of claim 2, wherein in step (1), the molar ratio of the lithium salt to the magnesium salt is in a range of 9:1 to 19:1.

4. The method for preparing the wide-temperature-range solid-state electrolyte of claim 2, wherein in step (1), the molar ratio of the lithium salt to the magnesium salt is 19:1.

5. The method for preparing the wide-temperature-range solid-state electrolyte of claim 1, wherein in step (1), the solvent is diethylene glycol; and the lithium salt in the mixed salt solution has a molar concentration of 1 mol/L to 10 mol/L.

6. The method for preparing the wide-temperature-range solid-state electrolyte of claim 1, wherein in step (1), the ammonia fluoride solution is a solution of ammonium fluoride in diethylene glycol; the ammonia fluoride solution has a concentration of 0.5 mol/L to 1 mol/L; and the ammonia fluoride solution is prepared under a protection of nitrogen or argon.

7. The method for preparing the wide-temperature-range solid-state electrolyte of claim 1, wherein in step (1), one or more of the following conditions are comprised:
i, the mixed salt solution is prepared under a protection of nitrogen or argon;
ii, the mixed salt solution is added dropwise to the ammonia fluoride solution;
iii, after mixing the mixed salt solution with the ammonia fluoride solution, the resulting mixture is stirred at room temperature for 3 minutes to 7 minutes to mix to be uniform;
iv, a ratio of a total molar amount of the lithium salt and the magnesium salt in the mixed salt solution to a molar amount of ammonia fluoride is in a range of 1:1 to 1:1.3; and
v, the reaction is carried out at a temperature of 70° C. to 100° C. for 1 minute to 5 minutes.

8. The method for preparing the wide-temperature-range solid-state electrolyte of claim 1, wherein in step (2), one or more of the following conditions are comprised:
i, the liquid plasticizer is 0.5 mol/L to 1.5 mol/L of a solution of lithium bistrifluoromethanesulfonimide (LiTFSI) in a mixed solvent of 1,3 dioxolane (DOL) and ethylene glycol dimethyl ether (DME); and in the mixed solvent, a volume ratio of the DOL to the DME is 1:1;
ii, in the polymer monomer, a volume ratio of the ETPTA to the HFBMA is in a range of 1:1 to 2:1; and
iii, the thermal initiator is azobisisobutyronitrile (AIBN).

9. The method for preparing the wide-temperature-range solid-state electrolyte of claim 1, wherein in step (2), a ratio of a mass of the magnesium-doped lithium fluoride nanoparticles, a volume of the liquid plasticizer, a volume of the polymer monomer, and a mass of the thermal initiator is in a range of 50 mg to 150 mg: 0.5 mL to 3 mL: 0.2 mL to 0.6 mL: 6 mg to 10 mg.

10. The method for preparing the wide-temperature-range solid-state electrolyte of claim 1, wherein in step (2), one or more of the following conditions are comprised:
i, the liquid precursor of the gel electrolyte is prepared under a protection of nitrogen or argon; and
ii, the curing is carried out at a temperature of 50° C. to 70° C. under the protection of nitrogen or argon for 1 hour to 6 hours.

11. A wide-temperature-range solid-state electrolyte prepared by the method of claim 1.

12. The method for preparing the wide-temperature-range solid-state electrolyte of claim 9, wherein in step (2), the ratio of the mass of the magnesium doped lithium fluoride nanoparticles, the volume of the liquid plasticizer, the volume of the polymer monomer, and the mass of the thermal initiator is in a range of 100 mg: 0.5 mL to 3 mL: 0.2 mL to 0.6 mL: 6 mg to 10 mg.
